(19) United States
(12) Patent Application Publication
(10) Pub. No.: US 2025/0332936 A1
(43) Pub. Date: Oct. 30, 2025

(54) CHARGING SOCKET DEVICE FOR A VEHICLE AND METHOD FOR RELEASE OF A PLUG-IN CHARGING CONNECTION

(71) Applicant: Lisa Dräxlmaier GmbH, Vilsbiburg (DE)

(72) Inventors: Daniel WILL, Loiching (DE); Florian SCHAFBERGER, Maxhütte-Haidhof (DE); Thomas WEISS, Adlkofen (DE)

(73) Assignee: Lisa Dräxlmaier GmbH, Vilsbiburg (DE)

(21) Appl. No.: 19/194,284

(22) Filed: Apr. 30, 2025

(30) Foreign Application Priority Data
Apr. 30, 2024 (DE) 102024112185.8

(51) Int. Cl. B60L 53/16; H01R 13/627; H01R 13/639

(52) U.S. Cl. CPC B60L 53/16; H01R 13/6278; H01R 13/6397; B60L 2270/34; H01R 2201/26

(57) ABSTRACT

A charging socket device for a vehicle includes a locking unit with a locking element, a carriage, and a plug-receiving unit. The locking element is movable between a locking position in which it projects transversely from a housing of the locking unit and a release position. The carriage includes a first slotted link element translationally mounted on a locking unit along the longitudinal direction between a disassembly position and an assembly position. The plug receiving unit includes a second slotted link element. One of the slotted link elements is a slotted link inclined relative to the longitudinal direction such that a movement of the carriage along the longitudinal direction causes a movement of the locking unit along a vertical direction of the charging socket device, and the other is a link pin. A slotted link mechanism of the charging socket device is formed by the slotted link elements.

### CROSS-REFERENCE TO RELATED APPLICATIONS

This application claims priority to DE 10 2024 112 185.8, filed Apr. 30, 2024. The disclosure of the above application is incorporated herein by reference.

### FIELD

The present disclosure relates to a charging socket device for a motor vehicle as well as a method for release of a plug-in charging connection.

### BACKGROUND

The statements in this section merely provide background information related to the present disclosure and may not constitute prior art.

Generally, charging connections have a locking mechanism, by means of which the charging plug of the charging cable is secured in the charging socket on the vehicle side and/or in the charging socket on the charging-point side are respectively secured against unplugging. A locking mechanism of this kind must be positioned particularly accurately, in order to provide its undisturbed operation. Conventional locking mechanisms, especially their actuators technology, are therefore, for example, screwed into position.

However, a screw connection of this kind inhibits fast release of the charging socket, since unscrewing the locking mechanism is tedious, and accessing the screw elements—in particular with chassis shapes that have a highly curved configuration—is not always possible without time-consuming dismantling of the vehicle. There is often no provision for removing the locking mechanism without removing the entire charging socket unit. Conversely, an easy assembly of the locking mechanism is frequently linked to a specific assembly sequence, wherein the charging socket unit and the locking mechanism are first assembled to form a component, which is subsequently installed.

### SUMMARY

This section provides a general summary of the disclosure and is not a comprehensive disclosure of its full scope or all of its features.

The present disclosure provides a simplified assembly and disassembly of a locking mechanism of a charging socket unit, to enable particularly easy release of a plug-in charging connection.

The present disclosure relates to a charging socket device, in which a vehicle which has the charging socket device or a chassis element, and a charging point that are initially connected to each other. The present disclosure provides a method to secure a plug-in charging connection by means of which the vehicle that is to be electrically charged and a charging point for electric power transmission are connected to each other by a charging cable, against unauthorized disconnection as well as against theft of the charging cable.

A charging socket device of a vehicle having a locking unit is proposed according to the present disclosure. The locking unit comprises a locking element, which is configured, for example, as a translationally movable locking pin. The position of the locking element can be adjusted between a locking position and a release position. In the locking position, the locking element projects out of a housing of the locking unit, transversely to a longitudinal direction (x) of the charging socket device, by an interlock measurement. In the release position, the locking element projects out of the housing by less than the interlock measurement or is fully recessed in the housing. The charging socket device further features a carriage, which is translationally movably mounted on the locking unit along the longitudinal direction (x) between a disassembly position and an assembly position. A first slotted link element is positionally fixed on the carriage. The charging socket device additionally features a plug-receiving unit on which a second slotted link element is positionally fixed. The charging socket device is free of another force-transmitting mechanism for moving the entire locking unit relative to the plug receiving unit.

One of the slotted link elements is configured as a slotted link, whereas the other corresponding slotted link element is configured as a link pin. A slotted link mechanism can be formed by means of the slotted link elements—that is, by means of the slotted link and the link pin—in that the two slotted link elements are mutually engaged, the link pin is thus inserted into the slotted link. Accordingly, the slotted pin mechanism is formed as soon as the two slotted link elements are mutually engaged, that is, the link pin is inserted into the slotted link. The slotted link is arranged transversely relative to the longitudinal direction (x), namely in such a way that a movement of the carriage along the longitudinal direction (x) causes a movement of the locking unit along the vertical direction (z) of the charging socket device.

An installation or assembly of the charging socket device takes place as follows: the locking unit and the plug receiving unit are initially located separately from each other and are positioned relative to each other along the vertical direction (z) of the charging socket device. The carriage is also moved first into the disassembly position. Then the locking unit and the plug receiving unit are moved toward each other along the vertical direction (z) until the slotted link elements mutually engage. The slotted link mechanism, in which the link pin is inserted into the slotted link, is thus formed—while the carriage is in the disassembly position—by mutually moving the locking unit and the plug receiving unit toward each other. By moving the carriage in assembly direction, that is from its disassembly direction in the direction of its assembly direction, the link pin slides into the slotted link along its wall, whereby the movement of the carriage along the longitudinal direction (x) in the direction of the assembly position causes a movement of the locking unit along the vertical direction (z)—the locking unit and the plug receiving unit are thus moved toward each other. The first and the second slotted link elements are positionally arranged in such a way that the locking unit and the plug receiving unit are arranged in the intended installation position once the carriage, when the slotted link elements engage, has been fully moved into its assembly position. The locking unit and the plug receiving unit are, in particular, tensioned against each other, if the carriage is arranged fully in the assembly position when the slotted link elements engage with each other. In this way, the locking unit and the plug receiving unit are efficiently and securely connected to each other when the carriage is moved into its assembly position. If the locking unit and the plug receiving unit have been suitably mutually connected, a positive locking fit between the locking unit and the plug receiving unit is formed by means of the slotted link mechanism, which blocks a pulling apart motion of the locking unit and the plug receiving unit along the vertical direction.

A complex manual relative alignment of the locking unit and the plug receiving unit can be dispensed within that the slotted link mechanism is produced by initially positioning the locking unit and the plug receiving unit relative to each other for assembly or installation and then tensioning them against each other by means of the slotted link mechanism by moving the carriage from its disassembly position into its assembly position. The locking unit is moved into a desired end position—with reference to the plug receiving unit—by means of the slotted link mechanism as a result of a movement of the carriage in the direction of the assembly position. Screws or other such fastening elements for connecting the locking unit and the plug receiving unit can also be omitted thanks to the charging socket device. It is furthermore advantageous that the assembly of the locking unit and the plug receiving unit is performed particularly quickly due to the slotted link mechanism, given the fact that, advantageously, tools may be omitted to connect the locking unit and the plug receiving unit.

It is particularly advantageous that an especially easy release of a plug-in charging connection is made possible by the charging socket device. The present disclosure provides a method for release of a plug-in charging connection. The method is based on the following initial situation: first, when there is a plug-in charging connection, the vehicle having the charging socket device and a charging point, such as a charging column, are first mutually connected by means of a charging cable. For this purpose, a charging socket of the charging cable and the plug receiving unit are coupled to each other, wherein the locking element arranged in the locking position engages in a locking element holder of the charging plug and in this way locks the plug against being pulled out of the charging socket device along the longitudinal direction. With this method, the carriage is now moved along the longitudinal direction (x) in disassembly direction—that is, from its assembly position in the direction of its disassembly position—so that the locking unit, together with the locking element arranged in the locking position, is moved along the vertical direction (z), whereby the locking element is moved out of the locking element holder of the charging plug. During the movement of the carriage in the direction of its disassembly position, the link pin once again slides along the walls of the slotted link, however now in a direction opposite to the direction of movement when assembling or installing the charging socket device. The locking unit and the plug receiving unit are thereby moved away from each other.

Thus, if there is a malfunction, and the locking element can no (longer) be moved into its release position, for example, if an actuator device for moving the locking element is defective, a user is enabled to simply release the positive lock of the charging plug. The user may not posses any special training to do this; the procedure can be carried out by anyone due to the simple design of the charging socket device. In addition, the release is non-destructive, that is, neither the locking unit nor the plug receiving unit nor the charging socket are damaged. Furthermore, installation of a new or repaired locking unit according to the assembly process presented above is particularly simple and utilizes a reduced effort.

According to a first design variant of the charging socket device, the first slotted link element arranged on the locking unit is configured as a slotted link, whereas the second slotted link element arranged on the plug receiving unit is configured as the link pin. In a second design variant of the charging socket device, which is different from the first design variant, the first slotted link element arranged on the locking unit is configured as a link pin, whereas the second slotted link element arranged on the plug receiving unit is configured as the slotted link. The further developments described in the following are applicable to the first as well as to the second design variant of the charging socket device.

In a possible further development of the charging socket device, the slotted link and the longitudinal direction together comprise an angle having a maximum of 45 degrees. The angle amounts to, for example, 30 degrees. The force with which the carriage is moved in the assembly direction or in the disassembly direction is particularly efficiently transformed through such an angle into a force with which the locking unit is moved along the vertical direction (z) toward the plug receiving unit. A force transmitting mechanism is created in this way, which advantageously allows a user to securely assemble the locking unit with particularly little effort. Resistances, such as assembly resistances to which movement of the locking unit toward the plug receiving unit are subjected in order to place seals in their sealing seat, etc., can be overcome particularly easily, or with little effort, due to the force transfer provided by the slotted link mechanism. Similarly, the user must apply only a little force to disassemble the locking unit, which supports the idea of a lock that is particularly easy to operate and release. If the locking unit adheres in an undesirable manner to the plug receiving unit, for example, due to contaminated or hardened sealing elements, etc., this adhesive force is easily overcome during the movement of the carriage in the direction of the disassembly position due to the slotted link being arranged transversely to the longitudinal axis.

According to a possible further development, the charging socket device has an arresting unit, by means of which the carriage can be arrested in its assembly position against movement along the longitudinal direction. The arresting unit has an arresting element, which is arranged on or in the slotted link. The link pin can be arrested in the slotted link by means of the arresting element in a position associated with the assembly position. For example, the arresting element is configured as a locally delimited elevation of one of the walls of the slotted link, or as a locally delimited narrow point of the slotted link, so that the arresting element must be passed with the link pin when the carriage is moved into its assembly position, as an arresting force must be exerted on the carriage to overcome the arresting element. The arresting force is higher than the movement force with which the carriage can be moved if the link pin and the arresting element do not touch each other. Because of the arresting element, which secures the link pin against movement in the slotted link in the assembly position of the carriage, it is provided that the carriage is not unintentionally moved out of its assembly position, possibly due to vibrations which occur during a driving operation of a vehicle equipped with the charging socket device, and act on the charging socket device.

As provided by a further possible example, the charging socket device features a centering unit having a first centering element or two or more first centering elements on the locking unit. The locking unit according to this example features a second centering element or two or multiple second centering elements at the plug receiving unit. The centering elements are respectively arranged in pairs (each one of the first centering elements in connection with respectively one of the second centering elements) for the purpose of mutually forming a respective positive lock, which blocks a movement of the locking unit along the longitudinal di-rection as well as along the transversal direction (y) of the charging socket device relative to the plug receiving unit. It is particularly provided that initially one or more of these positive locks is/are produced in order to assemble/install the charging socket device, which then functions as a linear guide for moving the locking unit and the plug receiving unit apart. The locking unit and the plug receiving unit can thus be particularly accurately aligned with respect to each other to assemble the charging socket device. In addition, the locking unit and the plug receiving unit are particularly securely fixed to each other positionally, so that, as intended, a relative movement of the locking unit relative to the plug receiving unit is inhibited.

According to another possible example of the charging socket device, it is free of any possible additional force-transmission mechanism—aside from the slotted link mechanism—which is configured to move the entire locking unit relative to the plug receiving unit. The movement actuators, which are configured to move the locking elements, are not included among these, since only the locking element, but not the entire locking unit, can be moved by them. In addition, moving the slotted link mechanism facilitates assembly and disassembly of the locking unit, so that assembly and disassembly can be carried out particularly easily. A Bowden cable in particular, as well as a spur gear or the like are dispensed with, as they have, on the one hand, many individual parts, and are, on the other hand, particularly complicated to put together and may be prone to defects.

In order to further simplify release for the user, another possible example provides that when the charging socket device is in the intended installation position, an operating portion—for example, a handle, etc.—of the carriage in an access area in the inside of a chassis element can be reached without using a tool. In other words: if the charging socket device is installed as intended in a vehicle, the operating portion of the carriage is located in the interior of the vehicle. It is conceivable, for example, that the operating portion is arranged inside the wheel housing of the vehicle. In order to protect the operating portion of the carriage from unauthorized access, a possible further development provides that the operating portion of the carriage, in the intended installation position of the charging socket device, is arranged in an area of the interior of the vehicle which can be unlocked only by means of an unlocking element for the vehicle, possibly by means of a key element encoded for the vehicle that is normally used to unlock or lock the passenger compartment of the vehicle and/or to activate the vehicle. It should be understood that the unlocking or key element is not a tool; it is thus not a screwdriver or another tool, but rather an element that an end-user of the vehicle utilizes for the normal operation of the vehicle.

Other advantages, features, and details of the present disclosure can be drawn from the following description of possible examples, as well as from the drawings. The features and feature combinations mentioned previously in the description, as well as those mentioned below in the description of the figures and/or the features and feature combinations alone in the figures, can be used, not only in the respectively disclosed combination, but also in other combinations or individually, without exceeding the scope of the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a schematic sectional view of a charging socket device, wherein its locking unit and its plug receiving unit are presented separately according to one example of the present disclosure;

FIG. 2 shows a schematic sectional view of the charging socket device, wherein a slotted link mechanism for assembling the locking unit and the plug receiving unit has been produced according to one example of the present disclosure;

FIG. 3 shows a schematic sectional view of the charging socket device, wherein a movement of the slotted link mechanism is translated into a movement with which the locking and plug receiving unit are moved toward each other according to one example of the present disclosure;

FIG. 4 shows a schematic sectional view of the charging socket device, wherein a carriage of the locking unit is arrested in an arresting position according to one example of the present disclosure;

FIG. 5 shows a schematic sectional view of the charging socket device in fully assembled state, into which a charging plug of a charging cable can be inserted according to one example of the present disclosure;

FIG. 6 shows a schematic sectional view of the charging socket device, into which the charging plug in inserted and is secured against being pulled out by means of a locking element of the locking unit according to one example of the present disclosure;

FIG. 7 shows a schematic sectional view of the charging socket device in another variant, wherein its locking unit and its plug receiving unit are presented as separate from each other according to one example of the present disclosure; and

FIG. 8 shows a schematic sectional view of the further variant of the charging socket device which is fully assembled, and in which the charging plug is inserted and is secured against being pulled out by means of the locking element according to one example of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Explained below in a combined description are a charging socket device 1 as well as its assembly and disassembly and a method for release of a charging plug-in connection. Identical and functionally identical elements are provided with the same reference numerals in the figures.

FIGS. 1 to 5 show an assembly procedure, in which a locking unit 2 of the charging socket device 1 and a plug receiving unit 3 of the charging socket unit 1 are connected to each other. In the interest of simplicity, it is assumed in the following description that the plug receiving unit 3 is not moved during assembly. A coordinate system is also established, by means of which a longitudinal direction x, a transversal direction y, and a vertical direction z for the charging socket device 1 are defined. FIG. 1 shows a schematic and sectional view of the charging socket device 1, wherein its locking unit 2 and its plug receiving unit 3 are initially shown as separate from each other.

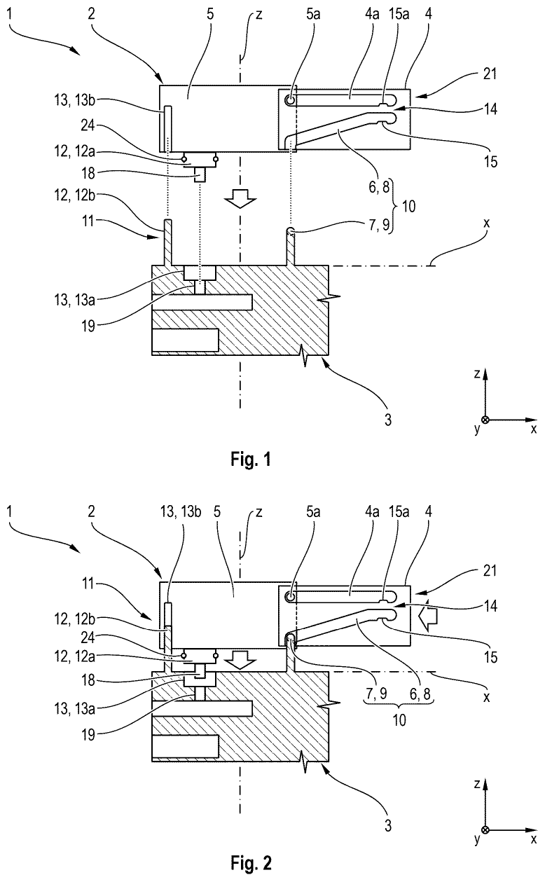

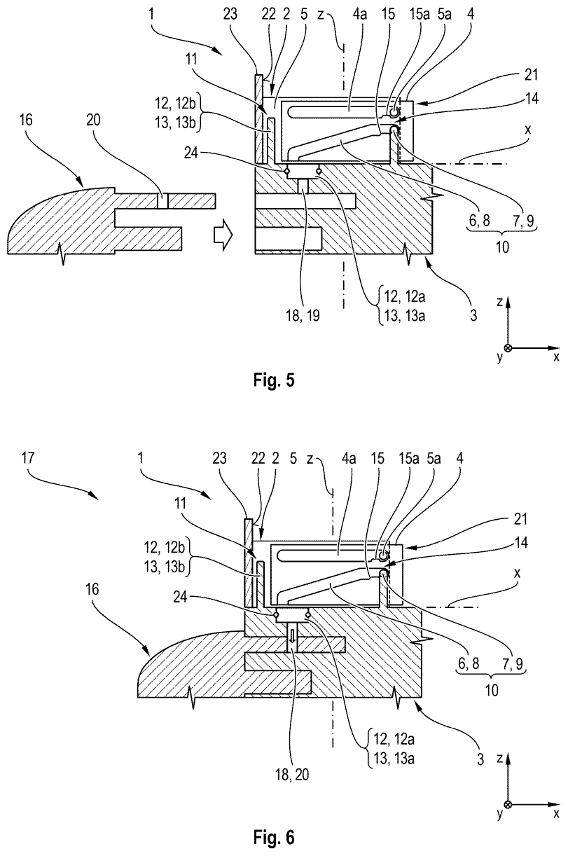

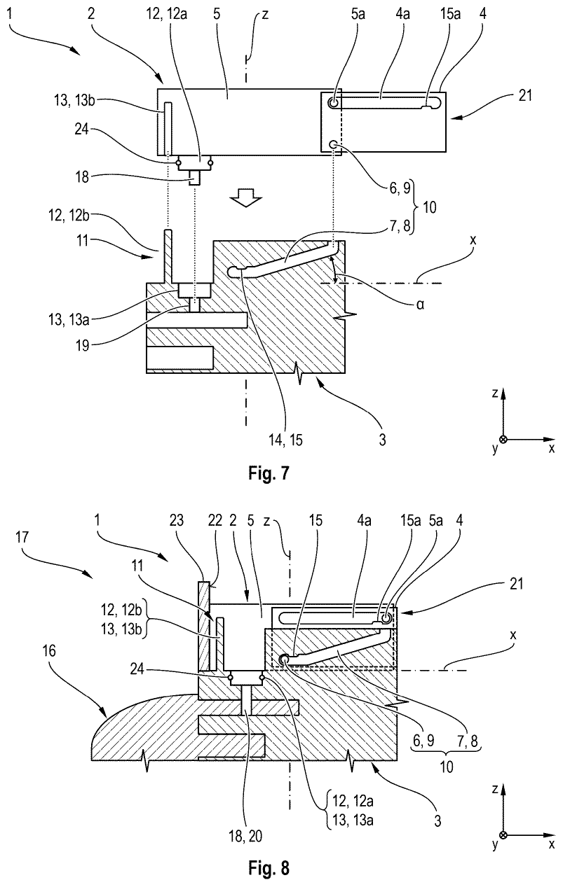

It can be seen in the figures that the charging socket device 1 features a carriage 4, which is translationally displaceably mounted on the locking unit 2, here on a housing 5 of the locking unit 2, along the longitudinal direction x between a disassembly position (see FIGS. 1 and 2) and an assembly position (see FIG. 5). For example, the carriage 4 features a straight elongated hole 4a, in which a guide pin 5a of the housing 5 fittingly engages. This is merely to be understood as an example; other and/or further types of linear bearings, by means of which the carriage 4 is mounted on the housing 5 are conceivable, for example, guide grooves in which the carriage 4 is bearing-mounted embedded, or the like. A first slotted link element 6 is positionally fixed on the carriage 4. The charging socket device 1 additionally features a second slotted link element 7, which is positionally fixed on the plug receiving unit 3. In FIGS. 1 to 6, the charging socket device 1 is represented in a first variant, in which the first slotted link element 6 arranged on the locking unit 2 is configured as a slotted link 8, whereas the second slotted link element 7 arranged on the plug receiving unit 3 is configured as a link pin 9. A second variant of the charging socket device 1, which is different from the first variant, is represented in FIGS. 7 and 8. In the second variant of the charging socket device 1, the first connecting element 6 arranged on the locking unit 2 is configured as a link pin 9, whereas the second slotted link element 7 arranged on the plug receiving unit 3 is configured as the slotted link 8.

In any case, when assembling the charging socket device 1 by means of the slotted link elements 6, 7—that is, by means of the slotted link 8 and the link pin 9—a slotted link mechanism 10 is formed in that the two slotted link elements 6, 7 are caused to engage, as is shown in FIG. 2. The locking unit 2 is moved along the longitudinal direction x toward the plug receiving unit 3, whereby the slotted link elements 6, 7 are mutually caused to engage and the slotted link mechanism 10 is subsequently formed. The link pin 9 is also inserted into the slotted link 8 in this state.

It can also be seen from the figures that the charging socket device 1 features a centering unit 11 having a first centering element 12 arranged on the locking unit 2. The first centering element 12 is configured here in the example as a centering collar 12a. The centering unit 11 further features a second centering element 13, which corresponds to the first centering element 12 and is arranged on the plug receiving unit 3. Since in the example here the first centering element 12 is configured as the centering collar 12a, which protrudes from the housing 5 of the locking unit 2, the second centering element 13 is configured as a centering collar holder 13a of the plug receiving unit 3. In order to further facilitate the movement of the locking unit 2 toward the plug receiving unit 3, it is additionally provided in the previously described example that the centering unit 11 also has first centering elements 12, as well as additional corresponding second centering elements 13. It can thus be seen in the figure that one of the other first centering elements 12 is configured as a centering pin 12b, while one of the other second centering elements 13 is configured as a centering pin 13b. As a result of the interaction of the centering pin 12b and the centering pin holder 13b, movement of the locking unit 2 is guided along the vertical axis z relative to the plug-receiving unit 3 even before the centering collar 12a and the centering collar holder 13a are brought into contact. The centering elements 12b and 13b, and, as soon as they are in contact with each other, the centering elements 12a and 13a as well, function in each instance together in pairs, as a linear guide for assembly of the charging socket device 1. It can be seen that a positive lock, which blocks a movement of the locking unit 2 along the longitudinal direction x, as well as along the transversal direction y relative to the plug receiving unit 3, is formed by the centering elements 12, 13 of the centering unit 11. This applies, on the one hand, during the assembly of the charging socket device 1 and, on the other hand, in the finished installed state of the charging socket device 1.

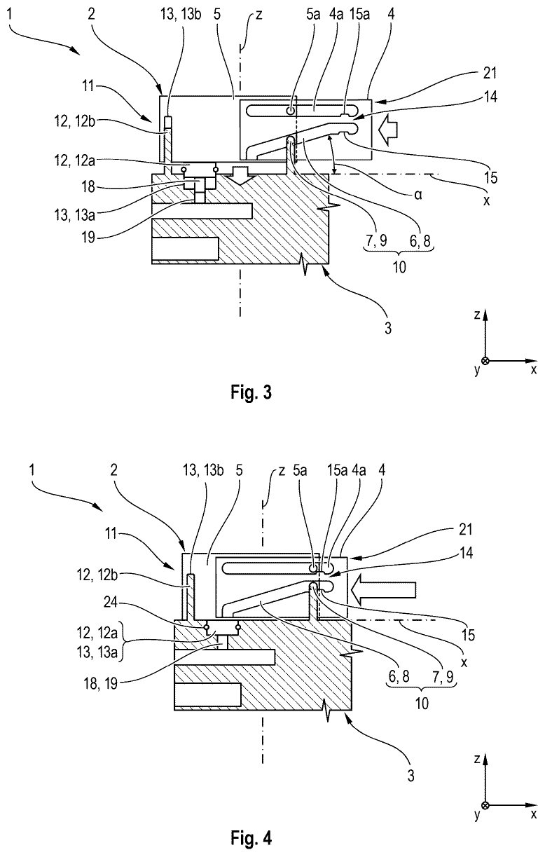

As already indicated in FIG. 2, the carriage 4 for the further assembly of the charging socket device 1 is moved out of its disassembly position (see FIGS. 1 and 2) by moving the carriage 4 along the longitudinal direction x in the direction of the assembly position (see FIG. 5), that is, in the assembly direction. As a consequence, the first slotted link element 6—in this variant thus the slotted link 8—which is positionally fixed on the carriage 4, is moved along the longitudinal direction x. FIG. 3 shows, in this respect, the charging socket device 1, wherein a movement of the slotted link mechanism 10 is translated into a movement by means of which the locking unit 2 is moved toward the plug receiving unit 3. It can be seen that the slotted link 8 is arranged at an angle relative to the longitudinal direction x in such a way that a movement of the carriage 4 along the longitudinal direction x causes a movement of the locking unit 2 along the vertical direction z. More precisely: the link pin 9 that engages with the slotted link 8 slides along the wall of the slotted link 8 into the slotted link as a result of the movement of the carriage 4 from its disassembly position (FIGS. 1 and 2) into its assembly position (FIG. 5), where-by the movement of the carriage 4 along the longitudinal direction x in the direction of the assembly position is translated into a movement of the locking unit 2 along the vertical direction z—that is toward the plug receiving unit 3, and thus here against the vertical direction z. FIG. 3 thus shows the charging socket device 1 during its assembly, when the carriage 4 has been moved out of its disassembly position (FIG. 1 and FIG. 2) but is not yet fully arranged in the assembly position (FIG. 5). The slotted link 8 and the longitudinal direction x comprise an angle α measuring no more than 45 degrees. In one example the angle α measures 30 degrees. The force with which the carriage 4 is moved into the assembly position is thereby translated particularly efficiently into a force with which the locking unit 2 is moved against the vertical direction z toward the plug-receiving unit 3.

In this state of the charging socket device 1—if the carriage 4, with engaged slotted link elements 6, 7, was moved from the disassembly position up to the connecting position shown in FIG. 4—the locking unit 2 and the plug receiving unit 3 are mutually connected to each other and are tensioned against each other along the vertical direction z. In FIG. 4, it can be seen that the slotted link elements 6, 7 are positionally arranged in such a way that the locking unit 2 and the plug receiving unit 3 are arranged in the intended installation position relative to each other as soon as the carriage with the engaging slotted link elements 6, 7 is moved into its connecting position.

According to the present example, the charging socket device 1 additionally features an arresting unit 14, by means of which the carriage 4 can be arrested in its assembly position against movement along the longitudinal direction x. The arresting unit 14 features an arresting element 15, which is arranged on or in the slotted link 8. The link pin 9, which is here in a position associated with the assembly position of the carriage 4 is arrested in the slotted link 8 by means of the arresting element 15. Here the arresting element 15 is formed as a locally delimited elevation of one of the walls of the slotted link 8, thereby producing a local narrow point of the slotted link 8 at the site of the elevation. When moving the carriage 4 into the assembly position, an arresting force that is greater than the movement force by means of which the carriage can be moved away from the arresting element 15 is applied to the carriage 4 along the longitudinal direction x. It can be also provided that the arresting unit 14 has additional arresting elements. It can, be seen, for example, from the figure, that an additional arresting element 15a can be configured as a further elevation, at this site only, of the elongated hole 4a.

FIG. 5 shows the charging socket device 1 in fully assembled state, wherein the carriage 4 is arranged entirely in the assembly position, so that on the one hand, the locking unit 2 and the plug receiving unit 3 are tensioned against each other along the vertical direction z by means of the slotted link mechanism 10, and on the other hand, a relative movement between the link pin 9 that engages in the slotted link 8 is arrested by the arresting unit 14. Also shown In FIG. 5 is a charging plug 16, which is part of a charging cable. The charging plug 16 can be inserted into the charging socket device 1, that is into the plug-receiving unit 3 of the charging socket device 1, in order to establish a plug-in charging connection 17, by means of which a purely electric or hybrid electric vehicle, that is its traction battery, and a charging point, for example, a charging column, can be coupled together to transmit electric energy. The charging plug-in connection 17 is shown in FIG. 6.

The locking unit 2 features a locking element 18, which is configured here as a translationally movable locking pin. The locking element 18 can be moved by means of a movement actuator (not shown; arranged in the housing 5 of the locking unit 2) between a release position and a locking position. In the locking position, the locking element 18 projects, transversely to the longitudinal direction x, by a locking measurement, from a housing 5 of the locking unit 2. The locking element 18, on the other hand, projects by less than the locking measurement from the housing 5, or is fully recessed into the housing 5. It can be seen in FIG. 5 that the locking element 18 is arranged in release position in order to enable the insertion of the charging plug 16 into the plug receiving unit 3. In the charging connection 17—see FIG. 6—the locking element 18 is arranged in the locking position and passes through a locking element opening 19 of the plug receiving unit 3 along the vertical direction z, wherein the locking element 18 engages in a positive locking manner in the locking element holder 20 of the charging plug 16. The charging socket 16 is thereby secured in the plug receiving unit 3.

It can be seen that the locking element 18, here the locking pin, is to be removed from the locking element holder 20 of the charging plug 16 in order to pull the charging plug 16 out of the charging socket device 1 without destroying it. If the charging socket device 1 functions as intended and does not malfunction, the movement actuator is accordingly driven for this purpose, so that the locking element 18 is moved into the release position by means of the movement actuator.

However, it can occur that the locking element 18 cannot be moved by the movement actuator into the release position, for example if the movement actuator is defective, it does not receive driving power, or the movement element is mechanically jammed in such a way that a movement force made available by the movement actuator is insufficient to move the movement element. The latter can happen if a sealing element 24, for example, a sealing ring, which is arranged here, for example, around the outer periphery of the centering collar 12a and seals the centering collar holder 12b in the assembled charging socket device 1 (see, for ex-ample, FIG. 4) has hardened and counteracts a simple movement of the centering collar 12a along the vertical direction z.

In this case, the method for release of the plug-in charging connection 17 comes into effect and is carried out as follows: the carriage 4 is moved along the longitudinal direction x in a disassembly direction that is opposite to the assembly direction (here in longitudinal di-rection x)—that is, out of the assembly position (see FIG. 4) in the direction of the disassembly position (see FIG. 1). The locking unit 2 is consequently moved together with the locking element 18 arranged in the locking position along the vertical direction z, whereby the locking element 18 is removed from the locking holder of the charging plug 16. With movement of the carriage 4 in the direction of the disassembly position, the link pin 9 again slides along the walls of the connecting pin 8, however now in the direction opposite to that of movement during assembly or installation of the charging socket device 1. The locking unit 2 and the plug receiving unit 3 are thereby moved away from one another and are thus detached from each other. Expressed more simply, the steps of assembling the charging socket device 1 are carried out in inverse order to implement the release. Tools may be omitted for assembly, the release can also be carried out completely without tools.

According to the present example, it is further provided that, aside from the slotted link mechanism 10, the charging socket device 1 does not feature another force-transmitting mechanism which is configured for moving the entire locking unit 2 relative to the plug receiving unit 3. The movement actuator is not involved in that. The charging socket device 1 does not, in particular, incorporate a Bowden cable, a spur gear, or the like. Therefore, only a movement of the slotted link mechanism 10 is utilized for the assembly or disassembly of the locking unit 2.

It is further provided that with the intended installation of the charging socket device 1, an operating portion 21 of the carriage 4 can be reached in the access area in the interior 22 of a chassis element 23 without using a tool. The operating portion 21 is especially configured as a handle or the like, so that a user can easily grasp it. If the charging socket device 1 is installed as intended in the vehicle, the operating portion 21 of the carriage 4 is situated on the wall of the interior of the vehicle. The operating portion 21 is in particular arranged in an area of the interior of the vehicle that can be unlocked by means of an unlocking element for the vehicle, possibly by means of an unlocking or key element encoded for the vehicle. The unlocking or key element is not a tool.

The second variant of the charging socket device 1 represented in FIGS. 7 and 8 differs from that first variant of the charging socket device 1 that was outlined previously in that the first slotted link element 6 arranged on the locking unit 2 is configured as the link pin 9, whereas the second slotted link element 7 arranged on the plug receiving unit 3 is configured as the slotted link 8. There are no other differences—either regarding the assembly and release or regarding the structure and function—compared to the first variant. The above description, starting with the state of the charging socket device 1 described in FIG. 7 up to the state of the charging socket device described in FIG. 8 therefore applies analogously to the second variant. Furthermore, the above description of the method for release of the charging plug-in connection 17 applies analogously to the second variant.

The inventive charging socket device 1 illustrates a means by which the assembly and disassembly of a locking mechanism of a charging socket unit could potentially be simplified. In addition, the charging socket device 1 allows for a release method for the plug-in charging connection 17 which is particularly easy to implement.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A charging socket device for a vehicle, comprising:
a locking unit including a locking element configured to move between a locking position, in which the locking element projects, by a locking measurement, transversely to a longitudinal direction of the charging socket device from a housing of the locking unit, and a release position, in which the locking element projects by less than the locking measurement from the housing,
a carriage including a first slotted link element that is fixed to the carriage, the carriage coupled to the locking unit and configured to translate along the longitudinal direction between a disassembly position and an assembly position,
a plug receiving unit including a second slotted link element that is fixed,
wherein the first slotted link element or the second slotted link element is configured as a slotted link, and an other of the first slotted link element or the second slotted link element is configured as a link pin, the slotted link and the link pin are configured to form a slotted link mechanism of the charging socket device, and the slotted link is arranged as inclined relative to the longitudinal direction such that a movement of the carriage along the longitudinal direction causes a movement of the locking unit along a vertical direction of the charging socket device.

2. The charging socket device according to claim 1, wherein the first slotted link element is the slotted link, and the second slotted link element arranged on the plug receiving unit is configured as the link pin.

3. The charging socket device according to claim 1, wherein the first slotted link element is the link pin, and the second slotted link element arranged on the plug receiving unit is configured as the slotted link.

4. The charging socket device according to claim 1, wherein the slotted link and the longitudinal direction define an angle of no more than 45 degrees.

5. The charging socket device according to claim 1 further comprising:
an arresting unit configured to fix the carriage in the assembly position against a movement along the longitudinal direction, and the arresting unit includes an arresting element that cooperates with the slotted link, wherein the link pin is configured to be fixed in the slotted link in a position associated with the assembly position of the carriage.

6. The charging socket device according to claim 1, further comprising:
a centering unit including a first centering element on the locking unit and a second centering element on the plug receiving unit, the first centering element and the second centering element are arranged to form a positive lock with each other to inhibit a movement of the locking unit along the longitudinal direction as well as along a transversal direction of the charging socket device relative to the plug receiving unit.

7. The charging socket device according to claim 1, wherein the charging socket device does not include another force-transmitting mechanism configured to move the locking unit relative to the plug receiving unit.

8. The charging socket device according to claim 1, wherein in an installation position of the charging socket device, an operating portion of the carriage in an access area in an interior of a chassis element is reachable without using a tool.

9. The charging socket device according to claim 1, wherein the locking element is fully recessed in the housing.

10. A method for release of a charging plug-in connection, in which a vehicle including the charging socket device configured according to claim 1 and a charging point are initially connected to each other via a charging cable, a charging plug of the charging cable and the plug receiving unit are coupled to each other, the locking element arranged in the locking position engages a locking element holder of the charging plug and inhibits the charging plug from being pulled out of the charging socket device along the longitudinal direction, and the method includes moving the carriage along the longitudinal direction from the assembly position in a direction of the disassembly position, and moving the locking unit and the locking element arranged in the locking position, along the vertical direction, to move the locking element out of the locking element holder of the charging plug.
